(19) United States
(12) Patent Application Publication
(10) Pub. No.: US 2007/0098481 A1
(43) Pub. Date: May 3, 2007

(54) Marking material

(75) Inventor: Andrew Arthur Hunter, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/492,150

(22) Filed: Jul. 25, 2006

(30) Foreign Application Priority Data
Oct. 29, 2005 (GB) 0522125.4

(51) Int. Cl. B43K 29/00

(52) U.S. Cl. 401/195

(57) ABSTRACT

A digital pen comprising a marking material for mark a product, the pen operable to determine its position relative to a portion of the product, wherein, following deposition from the pen, the marking material disappears or can be erased from the product.

The present invention relates to the Applicant's concurrently filed U.S. Patent Application HP Docket No. 200503446-2 entitled “USER-INTERFACE SYSTEM, METHOD & APPARATUS,” the content of which is entirely incorporated herein by reference.

### CLAIM TO PRIORITY

This application claims priority from co-pending United Kingdom utility application entitled, “Marking Material” having serial no. GB 0522125.4, filed Oct. 29, 2005, which is entirely incorporated herein by reference.

1. Field of the Invention

The present invention relates generally to a marking material for use with a digital pen.

2. Background

When writing entries on a product, such as a form for example, it is important that a user can see marks left by a pen. However, if the product is to be re-used it is important that any previous markings on the product do not interfere with the process of writing or the process of reviewing what has been written.

Paper based forms can be combined with digital pen technologies such that they are cheap enough to be discarded after use. Pads of identical forms can provide multiple copies of the same data entry or control functions (Anoto).

Specific pen or tablet-based computer applications often work with paper overlays that provide visible representations of controls and menu options. For example, CAD systems are often operated with a digital stylus and position-sensing tablet. Printed representations of common CAD functions are overlayed on the tablet such that selection of the printed functions with the stylus can be interpreted by the system as invocation of the corresponding CAD function. Such stylus and tablet interfaces do not lay down a trail of ink so the controls are not changed by their use. The disadvantage is that there is no direct visual feedback of actions such as writing (and usually a separate display device is required to show the effect of the actions of the stylus on the controls).

### SUMMARY

According to a first aspect of the present invention, there is provided a digital pen comprising a marking material for marking a product, the pen operable to determine its position relative to a portion of the product, wherein, following deposition from the pen, the marking material disappears or can be erased from the product.

According to a second aspect of the present invention there is provided a user-interface system comprising a digital pen operable to determine its position relative to a portion of a product, the pen comprising a marking material for marking a portion of the surface of the product, wherein marking material deposited on the product can be erased or disappears.

According to a third aspect of the present invention there is provided a method for the repeatable marking of a portion of a surface of a product, the method comprising marking the product using a digital pen by applying a marking material to the product surface, the pen operable to determine its position relative to the product surface portion being marked, wherein the applied marking material disappears or can be erased from the product surface.

### BRIEF DESCRIPTION OF THE DRAWINGS

For a better understanding of the present invention, and to further highlight the ways in which it may be brought into effect, embodiments will now be described, by way of example only, with reference to the following drawings in which:

FIG. 1 shows the component parts of a document according to an embodiment of the invention;

FIG. 2 is a schematic diagram of a user-interface system for processing the document of FIG. 1;

FIG. 3 is a flow diagram representing an exemplary procedure according to an embodiment; and

FIG. 4 is a schematic representation of a system according to an embodiment.

It should be emphasised that the term “comprises/comprising” when used in this specification specifies the presence of stated features, integers, steps or components but does not preclude the presence or addition of one or more other features, integers, steps, components or groups thereof.

### DETAILED DESCRIPTION OF PREFERRED EMBODIMENTS

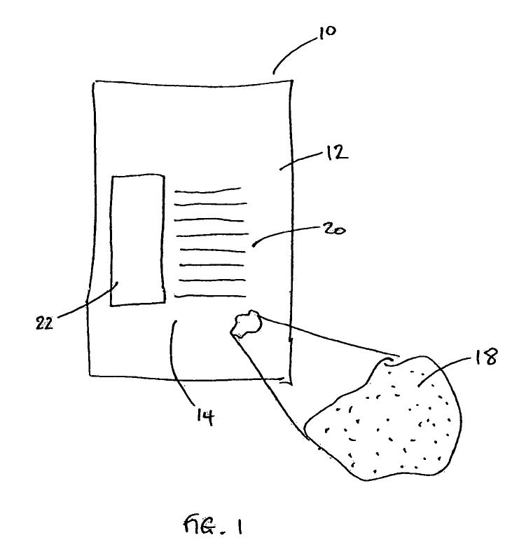

Referring to FIG. 1, according to an embodiment, a document 10 according to an embodiment comprises a paper substrate 12 having content 14 printed on it. The document 10 is a form, and the content 14 comprises text 20 and graphics 22. The document 10 has a position identifying pattern 18 printed onto its surface. The position identifying pattern can take a number of forms. For example, it may comprise a number of dots printed at predetermined positions on an imaginary grid, as described in our co-pending patent application GB 0321174.5, or as described in WO 01/26032. Other alternatives are possible.

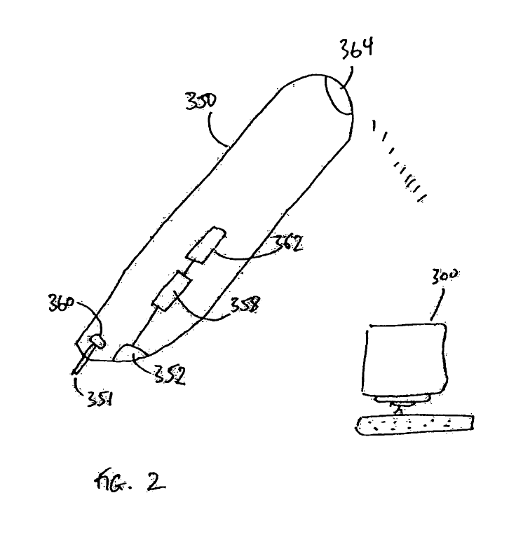

Referring to FIG. 2, a pen 350 for reading the pattern areas comprises a writing nib 351, and a camera 352. The camera 352 is arranged to image an area adjacent to the tip of the pen nib 351. A processor 358 processes images from the camera 352 taken at a predetermined sample rate. A pressure sensor 360 can detect when the nib 351 is in contact with the document 10 and trigger operation of the camera 352. Whenever the pen is being used on a patterned area of the document 10, the processor 358 can therefore determine from the pattern 18 the position, within the defined pattern area, of the pattern 18 over which the pen 350 is being passed. The sequence of positions can be saved in a pen memory 362 as pen stroke data, and can be transmitted to a PC 300 via a radio frequency transmitter 364, for example, in the pen 350. A cable (wired) connection can also be used. When the pen 350 is used to write on the document 10, the camera 352 detects the pattern 18 using light that is reflected from the document. The pattern 18 can therefore be detected by the pen. This enables the pen to determine its position on the document 10.

According to an embodiment, pen 350 is operable to make marks on document 10 using ink with an index of refraction which matches the refractive index of the material from which document 10 is composed. Document 10, can be composed of conventional cellulose, or any other suitable material that scatters light to produce a white (or near white) appearance. More specifically, the ink can be a transparent fluid, and documents 10 can be backed with an optically black (or other colour as desired) layer. When the ink is absorbed by document 10 from the tip of pen 350, the irregular surface and any air gaps of the document which cause light scattering, are filled by the index matching fluid (ink), and the black (or other colour) on the rear of document 10 therefore shows through. Light is therefore transmitted by the document 10 and absorbed by the document backing instead of being reflected.

According to an embodiment, the ink used as described above, is a volatile fluid, and, advantageously, as soon as it is absorbed by the document it begins to evaporate. This has the effect that the mark revealed by the transparent ink and the backing (in whatever colour that may be), gradually disappears. Once the ink has evaporated, the document returns to its original state (colour), such as white for example. Therefore, advantageously, document 10 can be re-used whilst still providing direct feedback of any data written on it. An example is a box on a printed form which can be ticked to request information, or to initiate an order or re-order—the same box can be repeatedly marked in order to request information at a later time, or submit (or re-submit) an order for goods or services for example, at a later time. There is therefore no need to print a new form to include multiple boxes so that a new box can be ticked every time. Other alternatives are possible. The rate of evaporation of the deposited marking material (such as the ink for example) will depend on the material used, the material marked and environmental conditions such as ambient temperature and/or humidity etc. It is therefore difficult to predict, with any degree certainty, exactly how long it will take for the marking material to evaporate. However, the rate can be controlled to a certain extent by selection of the ink and material which is desired to be marked. it is envisaged that evaporation can occur within a given period which is more than several seconds, but less than several hours in certain circumstances. Other alternatives are possible, and in particular, a longer period of evaporation can be used (days for example).

According to a further embodiment, the ink need not decay over time, but could remain stable. The application of heat to the ink could cause the ink to then become transparent. The heat can be applied using a heating element of the pen, such an IR lamp for example, or by virtue of heating functionality of the paper as will be explained in detail below. Alternatively, the ink could be stable until it is overwritten with a second liquid which is adapted to cause the ink to evaporate. Further alternatively, paper can be adapted to react with ink used to mark it. For example, paper can comprise a reactant adapted to react with the ink thereby causing the ink to evaporate after a predetermined amount of time. Other alternatives are possible.

According to a further embodiment information written to a product, such as document 10, can be used as invocation of an order for goods or services. Once the order for the goods or services has been confirmed or accepted, or once the order has been despatched or received (if appropriate), the information on the document used to initiate the order can be erased. The erasure can be effected in a number of ways. For example, with the use of a stable ink, the user of the document who initiated the order can erase the data upon satisfactory receipt of the goods, services, or upon receipt of confirmation etc. Alternatively the information can be erased upon delivery of the goods or services. The erasure can be effected by a person who has delivered for example. Alternatively, a volatile ink can evaporate after a given period of time.

Further alternatively, paper used to invocate an order (for goods or services for example) can comprise an inductively powered radio-frequency device, such as a memory tag for example. Such a device can be embedded in the paper, and can receive data when it is in the vicinity of a reader/writer. The device can comprise a memory and a transponder for enabling wireless communication with the device.

When an order has been placed, or confirmed, or despatched etc, a signal can be sent to the embedded device. When the device powers up and receives the signal, it can process the signal in order to determine the outcome of an order. The signal can comprise data operable to cause the device to trigger a heating element, which can also be embedded in the paper, to heat up. The heat can cause a temperature dependent ink to evaporate.

Alternatively, a pen used to mark paper to invocate an order can receive data (using a wired or wireless link for example) relating to the fulfilment, or otherwise, of the order. The data can be used by the pen to remove or adjust the marking which was used to place the order. For example, a user can make a mark on paper to order goods and/or services. The ink used to make the mark can be heat sensitive, or sensitive to UV light for example. Data representing the order can be stored in a memory of the pen, and transmitted over a network (such as the internet for example) to a predetermined destination in order to place the order. Upon completion of some desired step, such as confirmation that the order has been received for example, data can be sent back to the pen. This data can be used by the pen to cause the mark to be adjusted or erased. For example, following receipt of the data, and when the pen detects that it is in the vicinity of the area on the paper where the mark was made, it can switch on a UV lamp, or switch to another ink source for example, so that when the mark is overwritten, or passed over by the pen, the mark disappears, thereby confirming the completion of the step. As position data relating to the original marking is known, the pen can cause the UV lamp, or change of ink to be switched on only at positions on the paper corresponding to areas where the marking exists.

Accordingly, a pen-based user interface system is operated by a digital pen which comprises a marking material such as an index-matched transparent ink for marking a product. The product can be a document composed of paper with a refractive index which is marched by the index of the ink for example. The pen can be sued to fill in a form printed on the paper. The user will see marks on the paper as if the marks were written using ‘normal’ ink The pen can detect both the marks which have been made, and a data encoding pattern printed on the paper. The data encoding pattern can be sufficiently inconspicuously printed on the document to remain undetectable by the user.

According to an embodiment, a product, such as a carrier for example, can comprise a plurality of index images relating to digital images, video portions or sound clips for example. The carrier, and more specifically, the index images (or tick boxes, for example, associated therewith) can be marked in order to indicate which of the images (or video portions) the user desires to print, email, order etc. As the marking is adapted to disappear as described above, the index sheet can be re-used, which is advantageous as a user may not wish to print another ‘clean’, i.e. unmarked, index sheet again.

It will be appreciated that although reference is made herein to a pen, or a digital pen, this is not intended to be limiting. Any device or detector can be used. For example, a mobile station such as a mobile telephone, or a PDA can be used if the devices have the ability to mark a carrier such as paper on which the pattern is presented.

Further, it will be appreciated that a detector such as a digital pen can determine its position relative to a portion of a product in a number of ways, and the use of a data encoding pattern on the product is not intended to be limiting. For example, if knowledge of content, for example, printed on the product surface is known, this can be compared with an image of a portion of the product surface generated using an image capture device of the pen. The comparison can be used to determine the pen position relative to the product surface. Other alternatives are possible. For example, a product can comprise pieces of material, such as metal for example. The pen can sense its position by triangulating its position using the pieces of material. For example, the pieces of metal, or other material, can be adapted to have different properties, and the pen can use this fact to determine its position relative to the pieces and hence the product. So, for example, the pen can hold a digital map of the printed content on all the pages of a manual. The pen can be provided with the product, already programmed with the appearance of the manual. A camera in the pen then detects any printed content close to the position of the pen tip and searches the stored content to work out exactly where the pen must be (allowing for perspective distortions). Such a pen could not detect absolute position on a blank page (because there would be no content to reference the position from) but could construct relative pen motions (after beginning to write) by imaging the ink from the pen strokes or by using paper fibre sensing technology. Alternatively, a blank page could have content that is printed in invisible IR ink that can be imaged by the camera, but by avoiding the need for invisible ink markings, the manual pages could be printed by the user on any available inkjet or laserjet printer, and a mechanism can be provided for loading the appearance of the pages into a digital pen. The pages of the manual can be printed to ensure there are always enough visible points of reference. Text boxes, tick boxes, and representations of controls can all be printed to ensure that visually distinct images will be sensed by the camera in the pen to allow it to identify the exact page and position within the page.

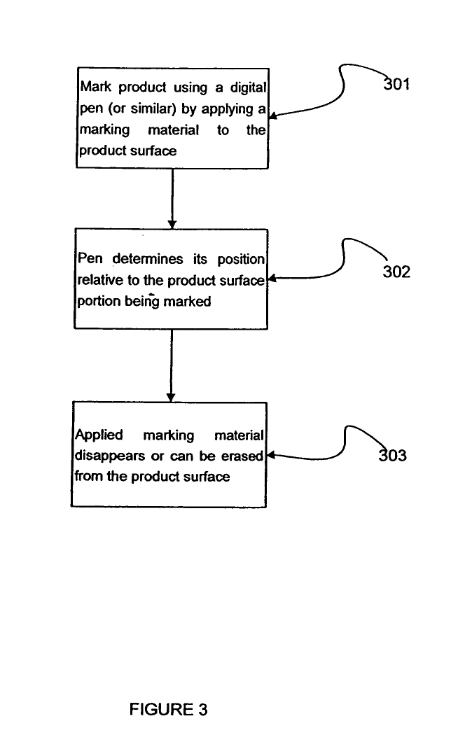

FIG. 3 is a flow diagram representing an exemplary procedure according to an embodiment. The procedure exemplifies a method for the repeatable marking of a portion of a surface of a product. More specifically, at step 301 a product is marked using a digital pen (or similar) by applying a marking material to the product surface.

The pen is operable to determine its position relative to the product surface portion being marked (302). At step 303, the applied marking material disappears or can be erased from the product surface. More specifically, the marking material can be adapted to disappear within a given period of time after application to the product.

The duration of the period can vary as explained above. For example, the marking material can be adapted to substantially evaporate from the surface. Alternatively, as explained, the marking material can be effectively permanent, and can be erased using suitable means. For example, the application of heat, and/or UV light (for example), and/or a suitable solvent to the deposited material can cause it to evaporate ‘on demand’. Suitable solvents for causing inks to evaporate are known. The marking material can be a fluid (ink for example), or a solid. In the case that the material is a solid, it can be a graphite material (such as found in pencils for example). In this case, erasing the material can be by using a suitable rubber eraser.

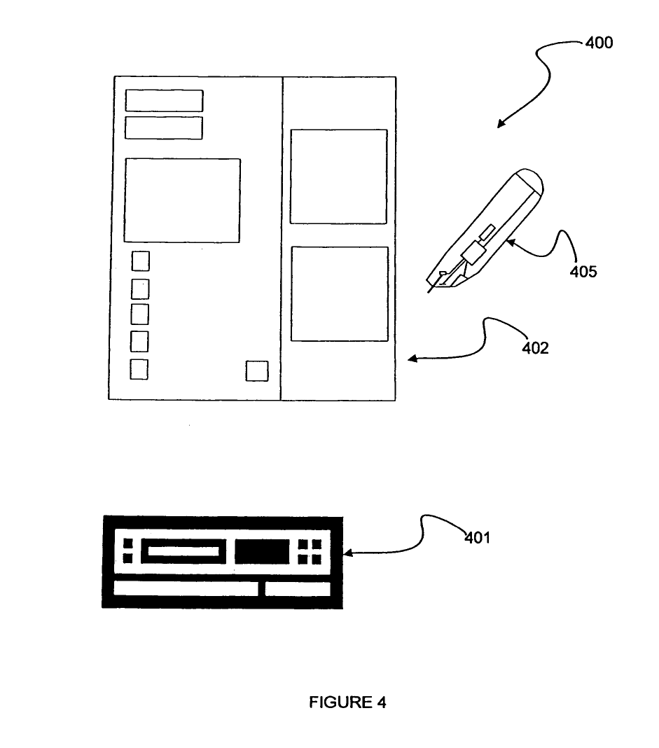

FIG. 4 is a schematic representation of a system 400 according to an embodiment. Digital pen 405 comprises a marking material for marking a product 402. Pen 405 is operable to determine its position relative to a portion of the product 402. Following deposition from the pen 405, the marking material disappears or can be erased from the product 402. The pen 405 can be used to wirelessly transmit data to a device 401. The transmitted data can relate to the markings which have been made by the pen 405 on the product 402. The product 402 is, in the case of FIG. 4, a document which comprises numerous areas in which data can be recorded by a user of pen 405. The areas in which data can be recorded on product 402 can comprise a data encoding pattern such as that of FIG. 1 to enable the pen 405 to determine its position relative to a portion of the product surface. Other alternatives for determining the pen position are possible as explained above.

1. A digital pen comprising a marking material for marking a product, the pen operable to determine its position relative to a portion of the product, wherein, following deposition from the pen, the marking material disappears or can be erased from the product.

2. A digital pen as claimed in claim 1, wherein the pen is operable to determine its position relative to a portion of the product using a data encoding pattern printed on at least the portion of the product.

3. A digital pen as claimed in claim 1, wherein the marking material disappears in a given period of time after the material has been deposited on the product.

4. A digital pen as claimed in claim 1, wherein the marking material is adapted to be erasable from the product by the application of any one of heat, UV light, or a suitable solvent to the deposited material.

5. A digital pen as claimed in claim 1, wherein the marking material is a liquid or a solid material.

6. A digital pen as claimed in claim 1, wherein the marking material is an ink which is transparent in the visible region of the spectrum.

7. A marking material for use in a digital pen as claimed in claim 1, the material adapted to disappear or be erasable from a product following application to a portion of a surface of the product.

8. A user-interface system comprising a digital pen operable to determine its position relative to a portion of a product, the pen comprising a marking material for marking a portion of the surface of the product, wherein marking material deposited on the product can be erased or disappears.

9. A user-interface system as claimed in claim 8, wherein a refractive index of the marking material and a product layer are matched.

10. A user-interface system as claimed in claim 8, wherein the marking material disappears in a given period of time after the material has been deposited on the product.

11. A user-interface system as claimed in claim 8, wherein the marking material is adapted to be erasable from the product by the application of any one of heat, UV light, or a suitable solvent to the deposited material.

12. A user-interface system as claimed in claim 8, wherein a refractive index of the marking material and a product layer are matched, the product comprising a coloured portion on the layer, such that marking the product at a point corresponding to the position of the coloured portion causes some of the coloured portion to become visible.

13. A user-interface as claimed in claim 8, wherein the product is a carrier having a substantially irregular surface comprising air gaps contributing to the scattering of light incident on said product, wherein the material is at least partially absorbed into at least some of the air gaps following application.

14. A user-interface system as claimed in claim 13, wherein light is absorbed by the coloured portion of the layer following application.

15. A user-interface system as claimed in claim 13, wherein the marking material is at least partially absorbed into at least some of the air gaps such that the material extends through the product from a point of application to the coloured portion of the layer following application.

16. A user-interface system as claimed in claim 8, wherein the marking material is an ink which is transparent in the visible region of the spectrum.

17. A method for the repeatable marking of a portion of a surface of a product, the method comprising:
marking the product using a digital pen by applying a marking material to the product surface, the pen operable to determine its position relative to the product surface portion being marked, wherein the applied marking material disappears or can be erased from the product surface.

18. A method as claimed in claim 17, wherein the applied marking material is adapted to disappear from the product surface within a predetermined period of time following application to the product surface.

19. A method as claimed in claim 17, wherein erasing the applied marking material comprises applying any one of heat, UV light or a solvent to the applied material.

20. A method as claimed in claim 17, wherein the product comprises a data encoding pattern printed on at least a portion thereof, the pen adapted to determine it position using the pattern.
